(19) United States
(12) Patent Application Publication
(10) Pub. No.: US 2025/0050359 A1
(43) Pub. Date: Feb. 13, 2025

(54) AIR BLOW GUN

(71) Applicant: KOGANEI CORPORATION, Koganei-shi, Tokyo (JP)

(72) Inventors: Yuji TAKAHASHI, Tokyo (JP); Takehiro KEMUYAMA, Tokyo (JP)

(21) Appl. No.: 18/698,242

(22) PCT Filed: Aug. 29, 2022
(86) PCT No.: PCT/JP2022/032435

§ 371 Date: Oct. 30, 2024

(30) Foreign Application Priority Data
Oct. 5, 2021 (JP) 2021-163917

(51) Int. Cl. B05B 5/053

(52) U.S. Cl. CPC B05B 5/0533

(57) ABSTRACT

An air blow gun 10 has: a main case 11 provided with a discharge nozzle 14; a unit accommodation chamber 29 detachably accommodating any of a pulse blow unit 31 that intermittently outputs, to an intermittent output end portion 39, air supplied to an intermittent input end portion 34 and a continuous blow unit that continuously outputs, to a continuous output end portion, air supplied to a continuous input end portion; a unit exchange lid by which the unit accommodation chamber 29 is opened/closed; and a manual valve 21 switched, by a trigger lever 24, between an open state in which the air discharged from the pulse blow unit 31 or continuous blow unit is discharged to a discharge nozzle 14 or a closed state in which the discharging is stopped.

### CROSS-REFERENCE TO RELATED APPLICATIONS

This application is a National Stage application of International Patent Application No. PCT/JP2022/032435, filed on Aug. 29, 2022, which claims priority to Japanese Patent Application No. 2021-163917, filed Oct. 5, 2021, each of which is hereby incorporated by reference in its entirety.

### TECHNICAL FIELD

The present invention relates to an air blow gun functioning both of a continuous blow gun that continuously discharges air toward an object and a pulse blow gun that intermittently discharges the air.

### BACKGROUND

An air blow gun is used to spray compressed air to an object such as a workpiece or a coated surface to remove chips, dust, and the like on the surface of the object. The air blow gun includes the continuous blow gun that continuously discharges air toward the object, and the pulse blow gun that intermittently discharges the air. Patent Document 1 discloses an intermittent air blow gun that intermittently discharges the air toward the object, that is, a pulse blow gun.

As described in Patent Document 1, the pulse blow gun has a switching valve for switching compressed air supplied from outside to intermittent air, that is, pulsed air, and the switching valve is also referred to as a pulse blow unit. The switching valve configuring the pulse blow unit has a spool type main valve, a small-diameter piston is provided at one end of the main valve, and a large-diameter piston is provided at the other end of the main valve. Each piston is incorporated in a pilot chamber inside a valve housing, and the air is intermittently discharged from the switching valve due to a change in thrust applied to both pistons.
Patent Document 1: Japanese Patent No. 6591686

### SUMMARY

Such a pulse blow gun has a throttle valve that causes a flow rate of air flowing into the pilot chamber to change in order to change a pulse interval, but cannot continuously discharge the air. A continuous blow gun needs to be used to continuously discharge the air to the object. That is, when both functions of the pulse blow and the continuous blow are required, two air blow guns must be prepared. Meanwhile, when a worker's operability is considered, it is desirable that shapes of the continuous blow gun and the pulse blow gun are the same.

An object of the present invention is to provide an air blow gun that functions as both a continuous blow gun and a pulse blow gun without changing the shape of the air blow gun.

An air blow gun of the present invention includes: a body case provided with a discharge nozzle for discharging air; a unit accommodation chamber formed in the body case so as to selectively accommodate both of a pulse blow unit and a continuous blow unit, the pulse blow unit intermittently outputting, to an intermittent output end portion, air supplied to an intermittent input end portion from outside, the continuous blow unit continually outputting, to a continuous output end portion, air supplied to a continuous input end portion from the outside; a unit exchange lid provided in the body case, and opening/closing the unit accommodation chamber; and a manual valve provided inside the body case, and switched to an open state or a closed state by a trigger lever, air discharged from the pulse blow unit or the continuous blow unit being discharged to the discharge nozzle in the open state, the discharge is stopped in the closed state, both of a continuous blow gun continuously discharging the air toward an object and a pulse blow gun intermittently discharging the air being applicable.

Since the unit accommodation chamber to which both the pulse blow unit and the continuous blow unit can be attached is provided in the body case, pulsed air can be blown to the object when the pulse blow unit is arranged in the unit accommodation chamber. Meanwhile, when the continuous blow unit is arranged, the air can be continuously blown to the object. In this way, by replacing the unit by the object according to a type of air blown to the object, the one air blow gun can be switched to either the function of the pulse blow gun or the function of the continuous blow gun without changing a shape of the air blow gun.

### BRIEF DESCRIPTIONS OF THE DRAWINGS

FIG. 1 is a perspective view showing an appearance of an air blow gun which is one embodiment viewed from a front surface side and a right side surface side;

FIG. 2 is a side view showing a left side surface of the air blow gun;

FIG. 3 is a perspective view showing a state in which a unit exchange lid provided on the right side surface of the air blow gun is opened;

FIG. 4 is a partial notch side view showing an interior of the air blow gun in a state of attaching a pulse blow unit;

FIG. 5 is a partial notch side view showing an interior of the air blow gun in a state of attaching a continuous blow unit;

FIG. 6 is an air pressure circuit diagram of the air blow gun, (A) showing a case where the pulse blow unit is attached to the air blow gun, and (B) showing a case where the continuous blow unit is attached to the air blow gun; and

FIG. 7 is an air pressure circuit diagram showing an operation of the air blow gun when the pulse blow unit is attached, (A) showing a state in which air is not supplied from outside to the air blow gun, (B) showing a state immediately after the air is supplied from outside, (C) showing a state in which the air is discharged from a nozzle by operating a manual valve, and (D) showing a state in which the air is discharged from the nozzle and the discharge of the air is stopped after a predetermined time elapses.

### DETAILED DESCRIPTION

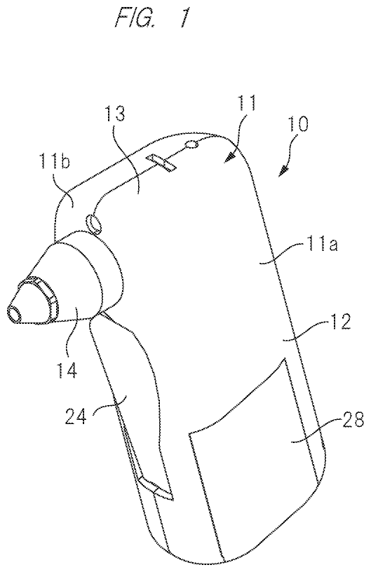

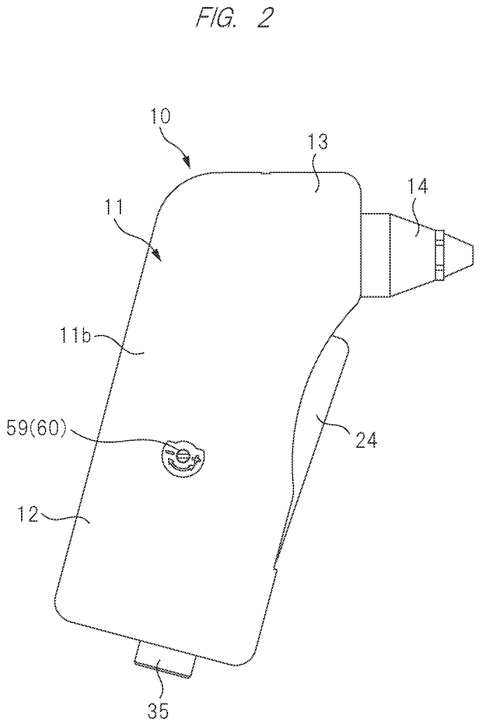

Hereinafter, embodiments of the present invention will be described in detail based on the drawings. As shown in FIGS. 1 and 2, an air blow gun 10 has a body case 11 as a gun body, and the body case 11 is assembled by butting two case halves 11a, 11b. A space for accommodating devices for configuring the air blow gun is formed inside the body case 11. The body case 11 has a grip portion 12 that a worker can grip by one hand, and a nozzle holding portion 13 at an upper end portion of the grip portion 12 in FIG. 1, and a discharge nozzle 14 made of a conductive material is provided in the nozzle holding portion 13 of the body case 11 so as to protrude from a foreside of the body case 11. A surface on which the discharge nozzle 14 is provided in the body case 11 is defined as a front surface.

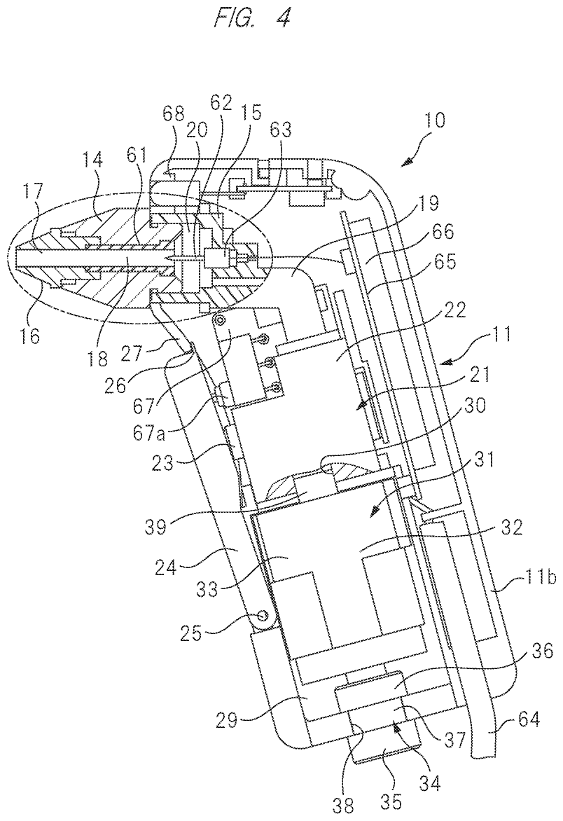

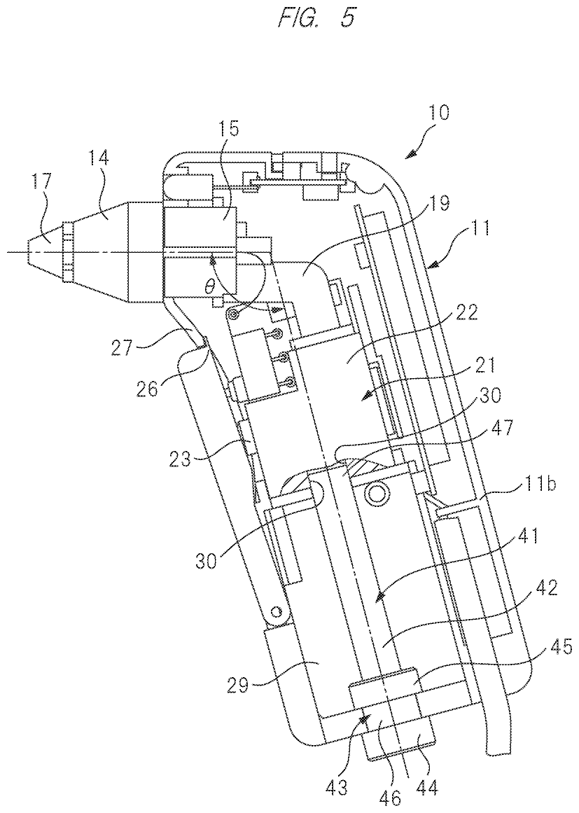

As shown in FIG. 4, the discharge nozzle 14 is attached to a nozzle holder 15 provided in a tip portion of the body case 11 and made of an insulating material. An air discharge port 16 made of a conductive material is attached to the discharge nozzle 14, and a discharge hole 17 formed in the air discharge port 16 communicates with a discharge flow path 18 formed in the discharge nozzle 14. As shown in FIG. 5, a center axis of the discharge nozzle 14 is inclined to the front surface at an angle θ with respect to the center axis in a longitudinal direction of the body case 11. The angle θ is an angle of about 105 to 110 degrees.

A manual valve 21 is incorporated in the body case 11 adjacent to the nozzle holder 15. The manual valve 21 is a two-port two-position directional control valve, and has a main valve incorporated in a valve housing 22 so as to be reciprocable in the axial direction, and a manual operation end portion 23 of the main valve protrudes to the frontside of the body case 11. A trigger lever 24 is provided on the front surface of the body case 11, and a lower end portion of the trigger lever 24 is rotatably supported on the body case 11 by a support pin 25. An engagement piece 26 is provided at an upper end portion of the trigger lever 24, and the engagement piece 26 is engaged with a stopper 27 of the body case 11.

The manual operation end portion 23 contacts with a back surface of the trigger lever 24. A spring force in a direction toward the trigger lever 24 is applied to the main valve of the manual valve 21 by a spring member incorporated in the valve housing 22. Consequently, a pressing force is applied to the trigger lever 24 in a direction in which the engagement piece 26 is engaged with the stopper 27. When the engagement piece 26 is engaged with the stopper 27 of the body case 11, the manual valve 21 is in a closed state, that is, an OFF state, and when the trigger lever 24 is pushed in by the worker, the main valve is driven to switch the manual valve 21 to an open state, that is, an ON state. When the manual valve 21 is switched to the ON state, compressed air flows out from an output port of the manual valve 21. Consequently, the compressed air flows out to the discharge flow path 18 via a communication chamber 20 of the nozzle holder 15 by an internal flow path of an outflow pipe 19 provided between the valve housing 22 and the nozzle holder 15.

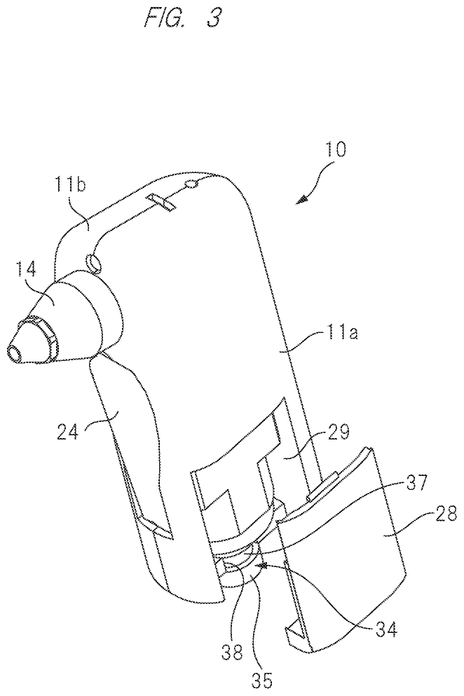

As shown in FIG. 1, the unit exchange lid 28 is located on the right side surface side of the body case 11 and is openably provided in the case half 11a. As shown in FIG. 3, when the unit exchange lid 28 for opening/closing the unit accommodation chamber 29 is removed from the body case 11, the unit accommodation chamber 29 formed in the body case 11 is exposed outside. The unit exchange lid 28 is fixed and attached to the body case 11 by a screw member or an engagement claw (not shown).

Any of the pulse blow unit 31 shown in FIG. 4 and the continuous blow unit 41 shown in FIG. 5 can be selectively arranged in the unit accommodation chamber 29.

As shown in FIG. 4, the pulse blow unit 31 has a switching valve 32 that converts compressed air supplied from outside into pulsed intermittent air. The switching valve 32 is a two-port two-position directional control valve and has a main valve that is incorporated in the valve housing 33 so as to be reciprocable in the axial direction, a small-diameter piston is provided at one end portion of the main valve, and a large-diameter piston is provided at the other end portion. A small-diameter pilot chamber into which the small-diameter piston is incorporated and a large-diameter pilot chamber into which the large-diameter piston is incorporated are formed in the valve housing 33.

An intermittent input end portion 34 to which compressed air is supplied from outside to the switching valve 32 is provided in the valve housing 33, and a flow path in the intermittent input end portion 34 communicates with an input port of the switching valve 32. The intermittent input end portion 34 has an input joint 35, and an air supply member (not shown) made of a tube or the like is detachably attached to the input joint 35. The air supply member guides the compressed air from a supply source of the compressed air to the intermittent input end portion 34. The intermittent input end portion 34 has a large-diameter flange portion 36, and a small-diameter portion 37 between the input joint 35 and the large-diameter flange portion 36 is detachably attached to an engagement hole 38 as an input end attachment portion formed in the body case 11.

An intermittent output end portion 39 is provided in the valve housing 33, and a flow path in the intermittent output end portion 39 communicates with an output port of the switching valve 32. A projection portion of the intermittent output end portion 39 is detachably attached to a fitting hole 30 as an attachment portion formed in the valve housing 22 of the manual valve 21.

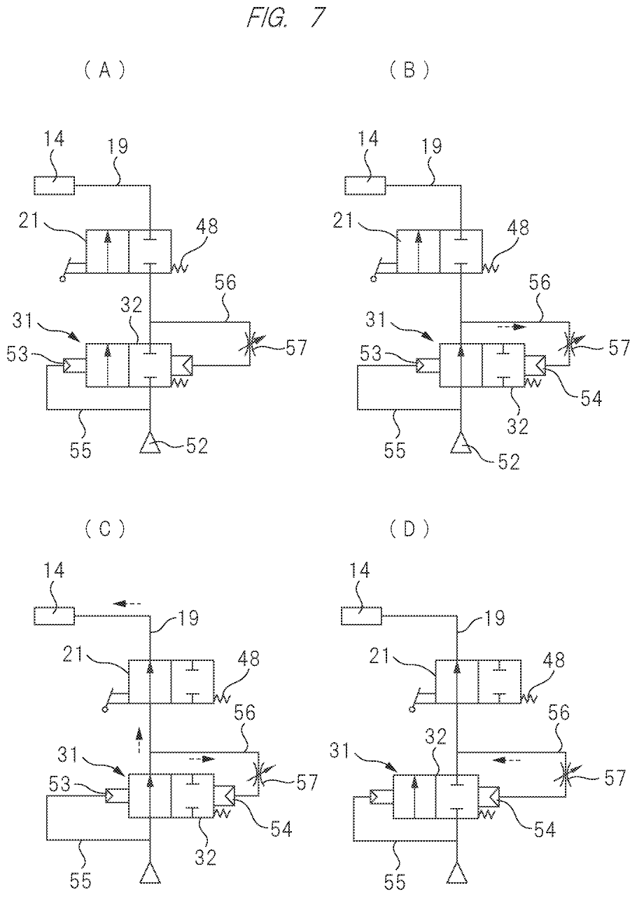

As will be described later with reference to FIG. 7, the switching valve 32 of the pulse blow unit 31 converts the air supplied from outside to the intermittent input end portion 34 into intermittent pulsed air to output it to the intermittent output end portion 39.

As shown in FIG. 3, the engagement hole 38 is formed by a semicircular hole formed at a lower end portion of the case half 11b and a unshown semi-circular hole formed at a lower end portion of the unit exchange lid 28. As shown in FIG. 3, when the unit exchange lid 28 is removed from the body case 11, the pulse blow unit 31 can be taken out from the unit accommodation chamber 29 in the body case 11. At that time, the intermittent output end portion 39 is removed from the fitting hole 30. When a seal member is provided in the fitting hole 30, a gap between the intermittent output end portion 39 and the fitting hole 30 can be sealed.

As shown in FIG. 5, the continuous blow unit 41 has a tube member 42 provided with a flow path inside, and a continuous input end portion 43 to which compressed air is supplied from outside is provided at the lower end portion of the tube member 42. The continuous input end portion 43 has an input joint 44, and an air supply member (not shown) made of a tube or the like is detachably attached to the input joint 44. The continuous input end portion 43 has a large-diameter flange portion 45, and the small-diameter portion 46 between the input joint 44 and the large-diameter flange portion 45 is detachably attached to the engagement hole 38 as an input end attachment portion formed in the body case 11.

An upper end portion of the tube member 42 configures a continuous output end portion 47, and the continuous output end portion 47 is detachably attached to the fitting hole 30 as an attachment portion formed in the valve housing 22 of the manual valve 21. An outer diameter of the small-diameter portion 46 of the continuous blow unit 41 is substantially the same as an outer diameter of the small-diameter portion 37 of the pulse blow unit 31. In addition, the outer diameter of the continuous output end portion 47 of the continuous blow unit 41 is substantially the same as the outer diameter of the intermittent output end portion 39 of the pulse blow unit 31. Further, a length between the large-diameter flange portion 45 of the continuous blow unit 41 and a tip of the continuous output end portion 47 is substantially the same as a length between the large-diameter flange portion 36 of the pulse blow unit 31 and a tip of the intermittent output end portion 39.

Therefore, any of the intermittent input end portion 34 and the continuous input end portion 43 can be engaged with the engagement hole 38, and any of the intermittent output end portion 39 and the continuous output end portion 47 can be fitted into the fitting hole 30 of the manual valve 21. Accordingly, any of the pulse blow unit 31 and the continuous blow unit 41 can be selectively arranged in the unit accommodation chamber 29 of the body case 11. Consequently, the air blow gun 10 functions as both the pulse blow gun and the continuous blow gun.

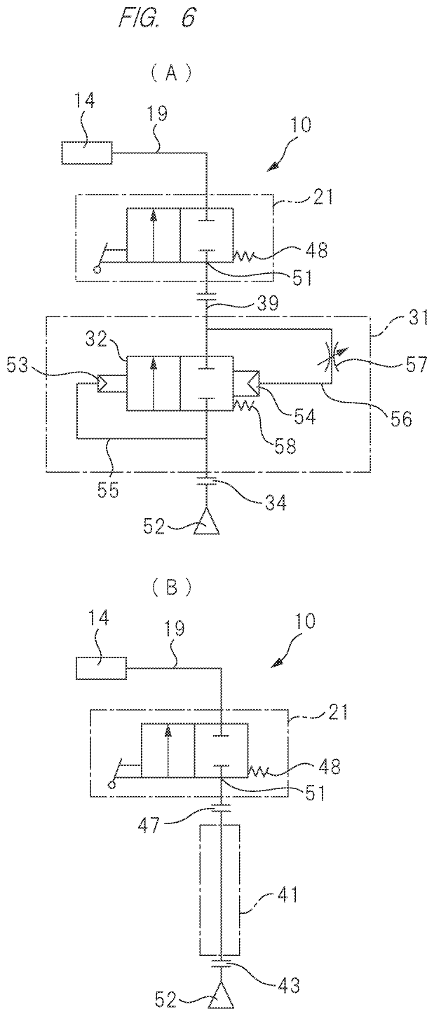

FIG. 6(A) is an air pressure circuit diagram of the air blow gun 10 when the pulse blow unit 31 is attached to the air blow gun 10, and FIG. 6(B) is an air pressure circuit diagram of the air blow gun 10 when the continuous blow unit 41 is attached to the air blow gun 10.

As shown in FIG. 6, the manual valve 21 is a two-port two-position directional control valve, and when the main valve is operated by the trigger lever 24, the input port 51 of the manual valve 21 communicates with a flow path of an outflow pipe 19 and the manual valve 21 becomes the ON state, and the compressed air that has passed through the manual valve 21 is discharged from the discharge nozzle 14. Meanwhile, when the trigger lever 24 is returned by the spring force of the spring member 48, the manual valve 21 becomes the OFF state and the communication between the input port of the manual valve 21 and an internal flow path of the outflow pipe 19 is blocked.

When the pulse blow unit 31 is attached in the unit accommodation chamber 29, the intermittent output end portion 39 communicates with the input port 51 of the manual valve 21 and the intermittent input end portion 34 communicates with an air supply member made of a tube or the like and connected to an air supply source 52. As shown in FIG. 6(A), the pulse blow unit 31 has a switching valve 32 that is a two-port two-position directional control valve, the small-diameter piston provided at the one end portion of the main valve is incorporated into the small-diameter pilot chamber 53 and the large-diameter piston provided at the other end portion of the main valve is incorporated in the large-diameter pilot chamber 54.

The small-diameter pilot chamber 53 communicates with the flow path of the intermittent input end portion 34 by a pilot flow path 55, and the large-diameter pilot chamber 54 communicates with the flow path of the intermittent output end portion 39 by a pilot flow path 56. A flow rate of air flowing through the pilot flow path 56 is adjusted by a variable throttle valve 57. A spring force in a direction of blocking the communication between the input port and the output port is applied to the main valve by the spring member 58. An operation knob 59 of the throttle valve 57 is provided in the pulse blow unit 31 and, as shown in FIG. 2, a through-hole 60 for operating the operation knob 59 from outside is provided in the grip portion 12. A through-hole 60 is provided in the grip portion 12. The through-hole 60 may be provided in the grip portion 12, or may be provided in the case halves 11a, 11b, or may be provided in the unit exchange lid 28. Further, when used as the continuous blow gun, the through-hole 60 may be closed by using a seal or a plug.

Meanwhile, when the continuous blow unit 41 is attached in the unit accommodation chamber 29, as shown in FIG. 6(B), the continuous output end portion 47 communicates with the input port 51 of the manual valve 21 and the continuous input end portion 43 communicates with the air supply member connected to the air supply source 52. Consequently, the compressed air from the air supply source 52 is directly supplied to the input port 51 of the manual valve 21.

FIG. 7 is an air pressure circuit showing an operation of the air blow gun 10 when the pulse blow unit 31 is attached to the unit accommodation chamber 29. FIG. 7(A) shows a state in which air is not supplied from the air supply source 52 and, at this time, the manual valve 21 and the switching valve 32 of the pulse blow unit 31 are in the OFF state. When the air is not supplied from the air supply source 52, both become the OFF state. FIG. 7(B) shows a state immediately after the air is supplied from the air supply source 52 to the input port of the switching valve 32, and the switching valve 32 becomes the ON state in which the input port and the output port communicate with each other by the air supplied to the small-diameter pilot chamber 53 from the pilot flow path 55.

Consequently, the air is supplied to the large-diameter pilot chamber 54 by the pilot flow path 56. The compressed air from the air supply source 52 is supplied to the small-diameter pilot chamber 53 and the large-diameter pilot chamber 54, but the switching valve 32 is switched off by the air and the spring force supplied to the large-diameter pilot chamber 54 having a large area. Time to be switched is set by adjusting the variable throttle valve 57. In this way, even if the air is supplied to the input port of the switching valve 32, the switching valve 32 maintains the OFF state when the manual valve 21 is not operated so as to be turned on.

As shown in FIG. 7(C), when the manual valve 21 is switched to the ON state, the air is discharged from the discharge nozzle 14 via the switching valve 32 and the manual valve 21. The compressed air that has passed through the switching valve 32 is branched into a flow passing through the manual valve 21 and a flow flowing into the large-diameter pilot chamber 54. By the air flowing into the large-diameter pilot chamber 54, the thrust is applied to the main valve in a direction of switching the switching valve 32 to the OFF state by the air supplied to the large-diameter pilot chamber 54, and the thrust is applied to the main valve in a direction of switching the switching valve 32 to the ON state by the air supplied to the small-diameter pilot chamber 53. When the thrust in the direction of switching the main valve to the OFF state due to a pressure of the large-diameter pilot chamber 54 increases, the switching valve 32 is switched to the OFF state as shown in FIG. 7(D). Consequently, the discharge of the air from the discharge nozzle 14 is stopped.

As shown in FIG. 7(D), when the switching valve 32 is switched to the OFF state, the air in the large-diameter pilot chamber 54 is discharged toward the discharge nozzle 14. A discharge speed is adjusted by the throttle valve 57. When the pressure in the large-diameter pilot chamber 54 decreases, the switching valve 32 is switched to the ON state, as shown in FIG. 7(C). In this way, by repeating the ON state and the OFF state of the switching valve 32, pulse blow is generated and is discharged from the discharge nozzle 14.

As shown in FIG. 4, a tube 61 made of an insulating material is incorporated in the discharge nozzle 14 made of a conductive material, and a discharge flow path 18 is formed inside the discharge nozzle 14 by the tube 61. A discharge electrode 62 configured by a discharge needle is attached to the nozzle holder 15 made of an insulating material. The discharge electrode 62 has a pedestal 63 fixed to the nozzle holder 15, and a tip portion thereof protrudes into the discharge flow path 18 of the discharge nozzle 14. The discharge nozzle 14 made of a conductive material configures a counter electrode, and when corona discharge is generated between the discharge nozzle 14 as the counter electrode and the discharge electrode 62, the compressed air flowing in the discharge flow path 18 is ionized.

A power cable 64 is attached to the grip portion 12 of the body case 11, and a transformer substrate 65 and a switch substrate 67 are provided inside the body case 11. The power cable 64 is connected to the switch substrate 67, and the switch substrate 67 is connected to the transformer substrate 65. An AC high voltage is applied between the discharge electrode 62 and the counter electrode configured by the discharge nozzle 14 from the power supply unit 66 provided on the transformer substrate 65. Consequently, corona discharge occurs around the pointed tip portion of the discharge electrode. When a positive high voltage is applied to the discharge electrode 62, the discharge electrode absorbs electrons in the air near the discharge electrode, so that the air near the discharge electrode becomes ions having a positive charge. In contrast, when a negative high voltage is applied to the discharge electrode 62, electrons are emitted from the discharge electrode, so that the air near the discharge electrode becomes ions having a negative charge. When ionized air is blown to a charged member such as an electronic component, charging is neutralized and adhesion of foreign matters to the member due to static electricity is prevented.

An electric switch 67a is provided on the switch substrate 67. The electric switch 67a contacts with the back surface of the trigger lever 24, and when the trigger lever 24 is pushed into by the worker, the electric switch 67a is turned on and the compressed air flowing in the discharge flow path 18 is ionized.

A lighting fixture 68 made of an LED is provided at the tip portion of the body case 11, and a discharge destination of the air can be illuminated by the lighting fixture 68.

When the pulse blow unit 31 is arranged in the unit accommodation chamber 29 of the body case 11, the above-mentioned air blow gun 10 can intermittently blow the air to the object. Meanwhile, when the continuous blow unit 41 is arranged in the unit accommodation chamber 29 instead of the pulse blow unit 31, the air can be continuously blown to the object. In this way, the air blow gun 10 has two functions by one, and can be applied to any of the pulse blow gun and the continuous blow gun. In addition, since the pulse blow gun and the continuous blow gun can be switched only by replacing the unit arranged in the unit accommodation chamber 29, both the pulse blow gun and the continuous blow gun can be functioned without changing the shape of the air blow gun.

Further, when the object is a charged member, the air can be ionized and blown to the object and the adhesion of the foreign matters due to the static electricity can be prevented on the object. Meanwhile, if the object is not charged, the unionized air can be blown to the object. In a form of blowing the air that does not ionize the air blow gun 10, it is possible to provide an air blow gun in a form in which the insulating tube 61, the discharge electrode 62, and the like are not provided.

The present invention is not limited to the above-described embodiments, and can be variously modified within a range not departing from the gist of the present invention.

The air blow gun of the present invention is used to spray compressed air to an object such as a workpiece or a coated surface to remove chips, dust, and the like adhered on the surface of the object.

While the present disclosure has been illustrated and described with respect to a particular embodiment thereof, it should be appreciated by those of ordinary skill in the art that various modifications to this disclosure may be made without departing from the spirit and scope of the present disclosure.

1. An air blow gun comprising:
a body case provided with a discharge nozzle for discharging air;
a unit accommodation chamber formed in the body case so as to selectively accommodate both of a pulse blow unit and a continuous blow unit, the pulse blow unit intermittently outputting, to an intermittent output end portion, air supplied to an intermittent input end portion from outside, the continuous blow unit continually outputting, to a continuous output end portion, air supplied to a continuous input end portion from the outside;
a unit exchange lid provided in the body case, and opening/closing the unit accommodation chamber; and
a manual valve provided inside the body case, and switched to an open state or a closed state by a trigger lever, air discharged from the pulse blow unit or the continuous blow unit being discharged to the discharge nozzle in the open state, the discharge is stopped in the closed state,
wherein both of a continuous blow gun continuously discharging the air toward an object and a pulse blow gun intermittently discharging the air are applicable.

2. The air blow gun according to claim 1,
wherein the manual valve has an attachment portion to which both the intermittent output end portion and the continuous output end portion are selectively attached, and the body case has an input end attachment portion to which both the intermittent input end portion and the continuous input end portion are selectively attached.

3. The air blow gun according to claim 1,
wherein the pulse blow unit is provided with a throttle valve and an operation knob for operating the throttle valve, and is provided with a through-hole for operating the operation knob in the body case.

4. The air blow gun according to claim 1,
wherein the pulse blow unit has: an intermittent output end portion attached to a fitting hole of the manual valve; a large-diameter flange and an input joint; and an intermittent input end portion configured by an input joint and a small-diameter portion having a smaller diameter than that of the large-diameter flange,
the continuous blow unit has: a continuous output end portion attached to the fitting hole of the manual valve; a large-diameter flange and an input joint; and a continuous input end portion configured by an input joint and a small-diameter portion having a diameter smaller than that of the large-diameter flange,
an engagement hole to which the small-diameter portion of the pulse blow unit or the small-diameter portion of the continuous blow unit is attached is provided in the body case.

5. The air blow gun according to claim 1,
wherein a nozzle holder to which the discharge nozzle is attached is provided in the body case,
a communication chamber for guiding the air, which flows out from the manual valve, to the discharge flow path provided in the discharge nozzle is formed in the nozzle holder,
by regarding the discharge nozzle as a counter electrode to generate corona discharge between the counter electrode and a discharge electrode, the discharge electrode for ionizing the air flowing through the discharge flow path is provided in the nozzle holder.
